(19) United States
(12) Patent Application Publication
(10) Pub. No.: US 2026/0154350 A1
(43) Pub. Date: Jun. 4, 2026

(54) ORGANIZING HETEROGENEOUS TYPES OF PROMPTS IN A METADATA MODEL FOR EASIER INPUT

(71) Applicant: SAP SE, Walldorf (DE)

(72) Inventors: Olivier Tsoungui, Viry Chatillon (FR); Christian Ah-Soon, Carrieres Sur Seine (FR)

(21) Appl. No.: 18/965,478

(22) Filed: Dec. 2, 2024

(51) Int. Cl. G06F 16/9035; G06F 16/9032

(52) U.S. Cl. CPC G06F 16/9035; G06F 16/90328

(57) ABSTRACT

An application generates a first user interface to enable a plurality of prompts to be combined into one or more groups of prompts, where each prompt of the plurality of prompts represents a filter for data targeted by subsequent queries. Next, the application generates a second user interface displaying the one or more groups of prompts in response to detecting that the plurality of prompts have been combined into the one or more groups of prompts in the first user interface. Then, a web intelligence engine executes a query in response to one or more values being specified, in the second user interface, for the one or more groups of prompts, where the one or more values filter the data returned by the query. Next, the web intelligence engine returns a result of the query to a first computing device based on executing the query.

### TECHNICAL FIELD

The present disclosure generally relates to organizing heterogeneous types of prompts in a metadata model for easier input.

### BACKGROUND

Modern enterprise software applications can collect and process vast amounts of data stored in various database systems. Some database systems store billions of records that are frequently accessed. For example, transactions can be repeatedly executed to access and/or manipulate data stored within a database system. In some examples, transactions include queries that are issued to the database system by clients (e.g., users, applications). For example, queries may be performed as part of various analysis applications. In analytics, a common goal is to retrieve data from one or more data sources to create a report dashboard. In case of huge data volumes, this might be difficult. Even modern technologies like current in-memory database systems come to their limits if the data volume is large enough. This results in subpar performance of the analysis application.

### SUMMARY

In some implementations, an application generates a first user interface to enable a plurality of prompts to be combined into one or more groups of prompts, where each prompt of the plurality of prompts represents a filter for data targeted by subsequent queries. Next, the application generates a second user interface displaying the one or more groups of prompts in response to detecting that the plurality of prompts have been combined into the one or more groups of prompts in the first user interface. Then, a web intelligence engine executes a query in response to one or more values being specified, in the second user interface, for the one or more groups of prompts, where the one or more values filter the data returned by the query. Next, the web intelligence engine returns a result of the query to a first computing device based on executing the query.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a system diagram of an example of a database system, in accordance with some example implementations of the current subject matter;

FIG. 3 illustrates an example of a user interface for creating prompts, in accordance with some example implementations of the current subject matter;

FIG. 4 illustrates an example of a user interface for creating a mandatory, non-exclusive group of prompts, in accordance with some example implementations of the current subject matter;

FIG. 5 illustrates an example of a user interface for creating an optional, non-exclusive group of prompts, in accordance with some example implementations of the current subject matter;

FIG. 6 illustrates an example of a user interface for creating an optional, exclusive group of prompts, in accordance with some example implementations of the current subject matter;

FIG. 7 illustrates an example of a user interface for displaying groups of prompts, in accordance with some example implementations of the current subject matter;

FIG. 8 illustrates an example of a user interface for displaying previously created groups of prompts prior to running a query, in accordance with some example implementations of the current subject matter;

FIG. 9 illustrates an example of a user interface for answering groups of prompts, in accordance with some example implementations of the current subject matter;

FIG. 10 illustrates an example of a user interface for answering groups of prompts in order to run a query, in accordance with some example implementations of the current subject matter;

FIG. 11 illustrates an example of a semantic layer for presenting data in a user-friendly format, in accordance with some example implementations of the current subject matter;

FIG. 12 illustrates an example of pseudocode to implement an algorithm for checking all answered prompts prior to running a query, in accordance with some example implementations of the current subject matter;

FIG. 13 illustrates an example of pseudocode of a portion of an algorithm for determining if all options have been complied with before executing a query, in accordance with some example implementations of the current subject matter;

FIG. 14 illustrates an example of pseudocode of a portion of an algorithm for determining if all options have been complied with before executing a query, in accordance with some example implementations of the current subject matter;

FIG. 15 illustrates an example of pseudocode of a function for determining if a prompt or a group of prompts has been answered, in accordance with some example implementations of the current subject matter;

FIG. 16 illustrates a process for creating groups of prompts for executing a query, in accordance with some example implementations of the current subject matter;

FIG. 17A depicts an example of a system, in accordance with some example implementations of the current subject matter; and

FIG. 17B depicts another example of a system, in accordance with some example implementations of the current subject matter.

### DETAILED DESCRIPTION

In analytics and business intelligence products, prompts are an important and visible feature that allow users to interactively narrow down datasets which are retrieved from various data sources. With data sources that may contains millions of records, filtering the queries by returning only the dataset corresponding to the prompts'answers ensures results are returned in a timely manner and are focused on business needs.

There are different types of prompts, such as (1) Authentication: To provide the account to connect to and the data source for retrieving data. Depending on this account, the security rights may change the values the user is allowed to see and hence the dataset returned by the query.

(2) Contextual: To provide a context that clarifies how computation must be performed. Context is a concept introduced in SAP BusinessObjects Universes as available from SAP SE, Walldorf, Germany. Context is based on the Semantic Layer model. For example, when a user queries a dataset for Products, Store, and Revenue, the Semantic Layer may expose two models, one for Future Revenue and one for Past Revenue. As the query does not provide enough information to define in which context the query must run, the Semantic Layer dynamically requests the context from the user.

(3) Filter: To narrow down the values to return. For example: “Select a list of Product(s)”, “Select a list of Year(s)”. Once the user has answered these prompts, their answers can be added to the query sent to the data source to filter the dataset to retrieve.

(4) Company or Vendor-specific variables: These prompts are specific to the business or database systems (e.g., SAP Business Warehouse (BW) systems, SAP HANA systems). A vendor-specific variable is a prompt that can be used to filter the values to return (data layer) or the object definition used to generate the queries (metadata).

Prompts can also have different properties, such as: (1) Mandatory: The user must answer a mandatory prompt before running the query. In general, mandatory prompts provide high discriminating filters that drastically reduce the dataset to retrieve from the data source.

(2) Optional: The user may answer an optional prompt before running a query to filter this dataset, but this is not mandatory. Not answering an optional prompt does not impact the query.

(3) Depending: A prompt's possible values may depend on the answers of another prompt. For example, if a prompt requests the user to select a list of cities, this list can be filtered by the user's answers to another prompt that requests the user to select a list of countries. In this case, the City prompt depends on the Country prompt and it makes sense to first ask the list of countries before the list of cities. For example, if the user selects USA as the country, there is no need to propose to the user cities outside of the USA.

(4) Merged: The same prompt can be used to filter several data sources when querying them. In this case, rather than asking the user to answer several prompts (one for each data source that exposes this prompt), it is more user friendly to merge these prompts into one and request for the user to answer only this prompt. The user's answers are then shared by all these merged prompts.

In most cases, providing good or expected answers for prompts can be difficult and time-consuming according to the document content. When report designers create operational documents (e.g., report, dashboard) that query many data sources (e.g., more than 20), they may face several difficulties:
(1) Non-ordered list of prompts. When the prompts are coming from different queries, these queries are not ordered, nor are the corresponding prompts. A model should be available to define in which order the prompts are displayed to the user.
(2) Illogical grouping of the prompts. Rather than displaying the prompts in a sequential list, it may be more user friendly to gather them in groups: Presenting them to the user by groups can ease the discovery and navigation among the prompts. Prompts that are semantically identical should be presented together. For example, all prompts related to a Product definition and its characteristics should be presented together.
(3) Inability to define a set of optional prompts as mandatory. Often report designers do not know how their users will filter down the dataset. They propose several possible optional prompts. Each prompt can be optionally answered. However, to make sure the user has provided at least one filtering criteria by answering at least one prompt, they want to force at least one of these optional prompts to be answered.
(4) Inability to force one and only one prompt among several prompts to be answered. A query can be filtered through different criteria. But if one of the criteria has been answered, answering the other ones may not be needed. For example, a person can be identified by their name, their email, or their ID number. However, it is inefficient to provide these three pieces of information when answering only one is enough to filter the dataset returned by a query that retrieves the piece of data related to this person.

To meet the previous requirements, the subject matter disclosed herein proposes to differentiate the different types of prompts and order and expose them to the user depending on their type. The subject matter disclosed herein also involves creating groups and sub-groups of prompts in a Semantic Layer used to query multiple data sources and to let the designer define how these prompts behave at query time through several options.

The following workflow describes how to create group of prompts and organize them to address the limitations previously described. A) Create a metadata model. In a Semantic Layer, define a metadata model that queries X data sources (X≥1). The data sources may rely on different technologies, each of them may leverage a set of prompts that must or may be answered before returning its dataset.
B) Define new prompts in the metadata model. In the metadata model (A), define new prompts to filter the datasets returned by the data sources that the Semantic Layer queries.
C) Define groups of prompts. In the metadata model, define N groups of prompts (N≥1). Each group of prompts contain at least one prompt defined either in a data source (A) or in the metadata model (B). Each prompt can belong to a maximum of one group.
D) Define group options. In each group defined in the metadata model (C), define if:

The group is mandatory or optional. If the group contains only optional prompts or optional groups of prompts, the designer can define the group as mandatory if the user must answer to at least one of its prompt(s) or group(s) of prompts. For example, a group named Geography containing the Country, City or State optional prompts may be set as mandatory if it is required to provide at least one of these locations before running a query. A group containing at least a mandatory prompt or another mandatory group of prompts is mandatory.

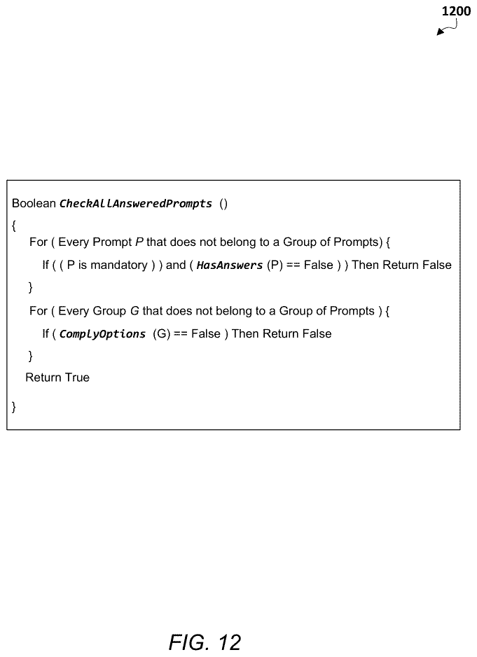

The group is exclusive or not. If the group contains only optional prompts or optional groups of prompts, the designer can define the group as exclusive if the user can answer one (and only one) of its prompts. For example, a group named User containing the Name, ID or Email optional prompts may be set as exclusive since answering one of its prompts is enough to identify a person without answering the other prompts. An exclusive group of prompts cannot contain mandatory prompts or mandatory groups of prompts; its prompts and groups of prompts can only be optional.
E) Create groups of groups. In the metadata model, it is also possible to define groups containing groups of prompts (D) and individual prompts. This recursive capabilities can be used to better organize the prompts by proposing multiple level of groups.
F) Order prompts and groups in groups. In each group defined in the metadata model (C), define the order to display the group's prompts and groups. This order defines how the prompts are displayed within these groups when the user must answer them. Groups within groups may be referred to as sub-groups or nested groups.
G) Order remaining prompts and groups. In the metadata model (C), define the overall order of: (1) Mandatory and optional prompts not used in groups of prompts, (2) Groups of prompts not used in other groups of prompts. Along with the order defined in each group (F), this order defines how the prompts are displayed when the user must answer the prompts.
H) Publish the metadata model and let users answer the prompts organized in groups. Once the steps that define the metadata model have been completed, this model can be shared for consumption by users through various reporting tools. Consumption can occur interactively in the application itself when running a query or consumpation can occur when creating a recurring schedule that will run the query on a fixed recurrence. In both cases, the user must answer prompts that are displayed to them. The prompts are displayed in an interface where: (1) The user must first answer authentication prompts, if any. (2) The user must then answer the contextual prompts, if any. (3) The other prompts are organized accordingly to the groups and orders defined in the metadata model (C), (E), (F), (G). (4) An algorithm to make sure all groups of prompts are properly answered is summarized in the CheckAllAnsweredPrompts, ComplyOptions and HasAnswers functions described below and shown in FIG. 12-15.

In an example, this algorithm takes into consideration: (1) Mandatory and optional parameters of prompts, groups, and sub-groups of prompts. Answering a mandatory group of prompts means: If this group contains only non-mandatory prompts, then at least one of these prompts must be answered. The group's mandatory prompts must also be answered. If this group contains prompts and sub-groups of prompts, then at least one of these prompts or sub-groups of prompts must be answered. If these sub-groups are also mandatory, then they must also be recursively answered. (2) Exclusive and non-exclusive parameters of the groups and sub-groups of prompts. Answering an exlusive group of prompts means that only one of its prompts or sub-groups of prompts can be answered.

The queries are run when the CheckAllAnsweredPrompts function returns True. To help the user answer these prompts, in the user interface: (1) Some icons highlight mandatory prompts, groups and sub-groups of prompts that are not yet answered. (2) The user cannot answer more than one prompt of an exclusive group of prompts. If the user attempts to answer more than one prompt of an exclusive group of prompts, the answers to the previously answered prompt of this exclusive group of prompts are reset.

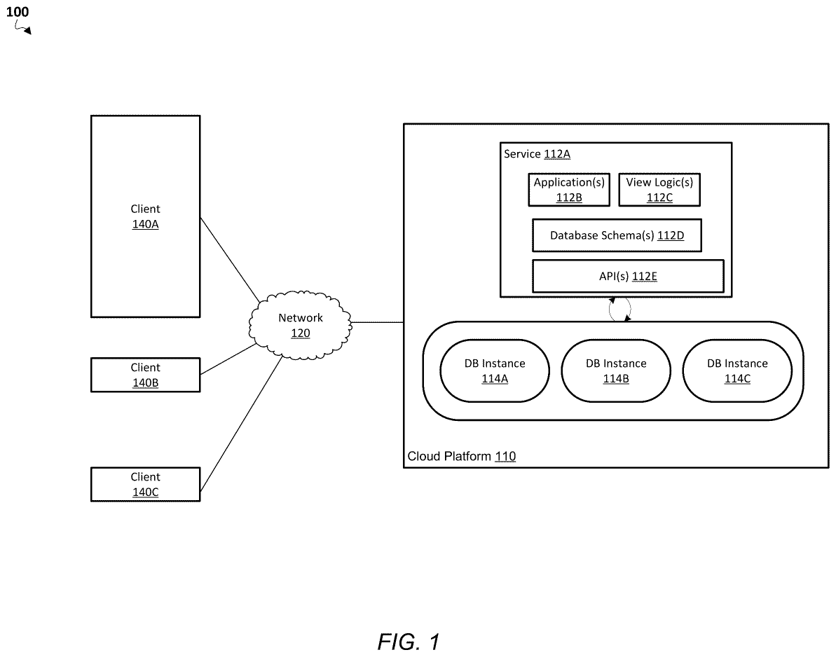

Referring now to FIG. 1, a diagram illustrating an example of a system 100 is depicted consistent with some implementations of the current subject matter. The system 100 may include a cloud platform 110 which provides resources that can be shared among a plurality of tenants. For example, the cloud platform 110 may be configured to provide a variety of services including, for example, software-as-a-service (Saas), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data, for example.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client (e.g., the first tenant 140A). This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client such as first tenant 140A). To illustrate further, the client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database instance 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

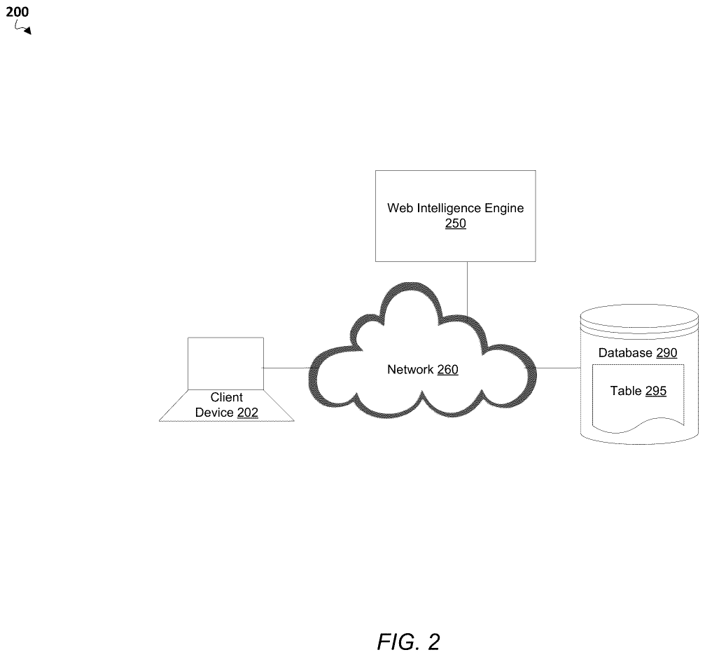

Turning now to FIG. 2, a system diagram illustrating an example of a database system 200 is shown, in accordance with one or more embodiments of the current subject matter. Referring to FIG. 2, the database system 200 may include one or more client devices 202, a web intelligence engine 250, and one or more databases 290. As shown in FIG. 2, the one or more client devices 202, the web intelligence engine 250, and the one or more databases 290 may be communicatively coupled via a network 260. The one or more databases 290 may include a variety of relational databases including, for example, an in-memory database, a column-based database, a row-based database, and/or the like. The web intelligence engine 250 may access a database table 295 at the one or more databases 290, with the database table 295 representative of any number and type of tables. The web intelligence engine 250 may be configured to generated queries for different types of databases and the corresponding persistent layers and/or tables therein. The web intelligence engine 250 may also be configured to utilize prompts to filter the data returned by queries, and the prompts may be grouped and presented to the user in an intuitive fashion that allows the prompts to be answered in an efficient manner.

In some example embodiments, the one or more databases 290 may include a relational database. However, it should be appreciated that the one or more databases 290 may include any type of database including, for example, an in-memory database, a hierarchical database, an object database, an object-relational database, and/or the like. For example, instead of and/or in addition to including a relational database, the one or more databases 290 may include a graph database, a column store, a key-value store, a document store, and/or the like.

The one or more client devices 202 may include processor-based devices including, for example, a mobile device, a wearable apparatus, a personal computer, a workstation, an Internet-of-Things (IoT) appliance, and/or the like. The network 260 may be a wired network and/or wireless network including, for example, a public land mobile network (PLMN), a local area network (LAN), a virtual local area network (VLAN), a wide area network (WAN), the Internet, and/or the like.

To illustrate by way of an example, a given client device 202 may send a query via the web intelligence engine 250 to the database layer including the one or more databases 290, which may represent a persistence and/or storage layer where database tables may be stored and/or queried. Furthermore, the web intelligence engine 250 may provide the ability to access table storage via an abstract interface to a table adapter, which may reduce dependencies on specific types of storage and persistence layers, which may in turn enable use with different types of storage and persistence layers.

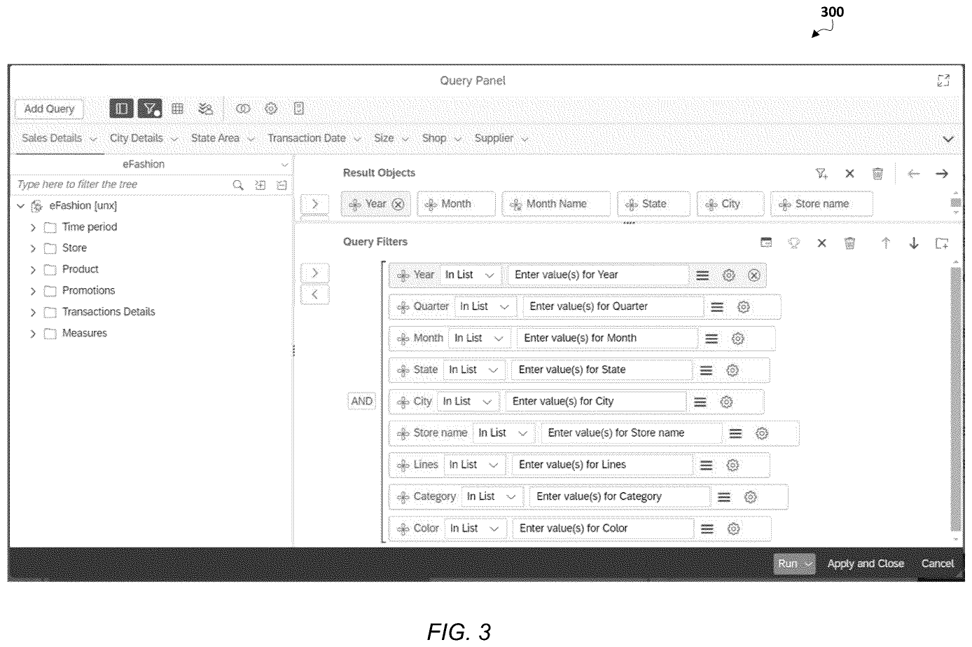

Referring now to FIG. 3, an example of a query panel user interface 300 is depicted, in accordance with one or more embodiments of the current subject matter. In an example, query panel user interface 300 includes a list of query filters to allow a user to filter the results targeted by a given query. The query filters are shown in the bottom right of the user interface. These filters include year, quarter, month, state, city, store name, lines, category, and color. In other embodiments, other types of filters may be presented in a user interface for selection by a user. It is noted that the terms “user interface” and “graphical user interface” may be used interchangeably herein.

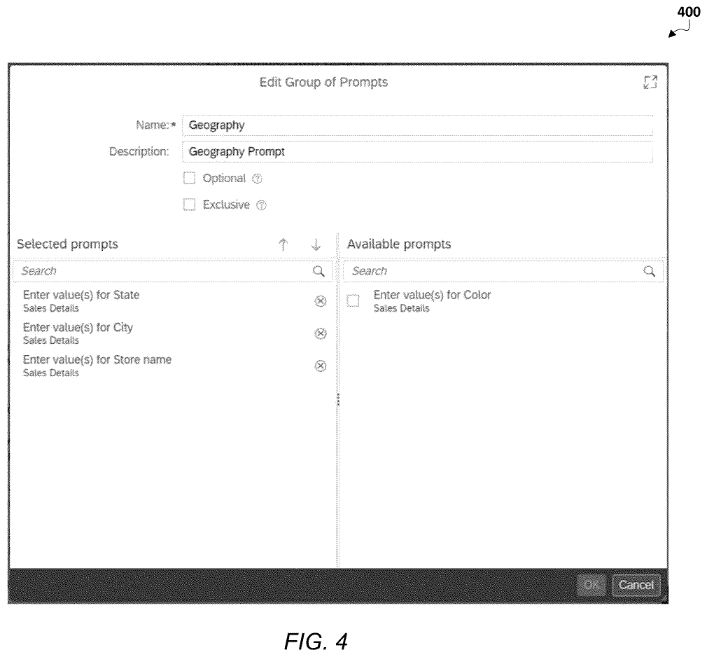

Turning now to FIG. 4, an example of a user interface 400 for creating a group of prompts is depicted, in accordance with one or more embodiments of the current subject matter. In order to improve the ordering of prompts and increase the efficiency of users interacting with the prompts before executing a query, prompts may be combined into groups to make a more intuitive presentation of the prompts in a user interface of a web intelligence engine (e.g., web intelligence engine 250 of FIG. 2). Accordingly, user interface 400 is an example of a user interface for creating a group of prompts. Generally speaking, user interface 400 may receive various types of user inputs to configure the user interface of a web intelligence engine in a customized manner for more efficiently filtering datasets retrieved by queries.

At the top of user interface 400, a name may be entered for the group of prompts. In this case, the name of the group of prompts is “Geography”. Also, below the name, a description of the group may be entered, with the description in this case including the text “Geography Prompt”. Below the description, two settings are displayed. The first setting specifies whether the group of prompts is optional. If the optional box is selected, this means that the prompts in the group are optional, and that the user does not have to answer the prompts prior to running the query. The second box specifies whether the group of prompts is exclusive. If the exclusive box is selected, then the user only needs to answer one of the prompts in the group of prompts.

On the bottom left of user interface 400, the prompts which are selected to be included in the group are shown. These prompts include the state, city, and store name. The up and down arrows to the right of the “Selected prompts” text allow the individual prompts to be moved up or down in the group to a desired position within the group. This positioning will be how the group of prompts are later presented to the user when the user is configuring their query. To the right of the selected prompts are the available prompts, which are other prompts which are available for adding to the group if the user so chooses.

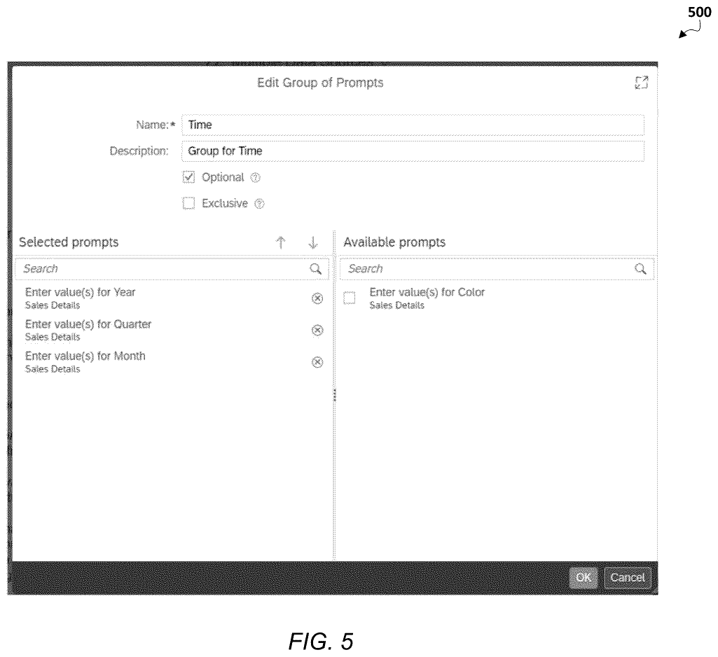

Referring now to FIG. 5, an example of a user interface 500 for creating a group of prompts is depicted, in accordance with one or more embodiments of the current subject matter. In user interface 500, a group of prompts with a group name of “Time” is created, and the optional setting is selected meaning this group of prompts is optional for the user to select before performing the query. The selected prompts for the group are shown in the bottom left of user interface 500, and these selected prompts include year, quarter, and month. The up and down arrows to the right of the “Selected prompts” text allow the individual prompts to be moved up or down in the group to a desired position within the group. This positioning will be how the group of prompts are later presented to the user when the user is configuring their query. To the right of the selected prompts are the available prompts, which are other prompts which are available for adding to the group if the user so chooses.

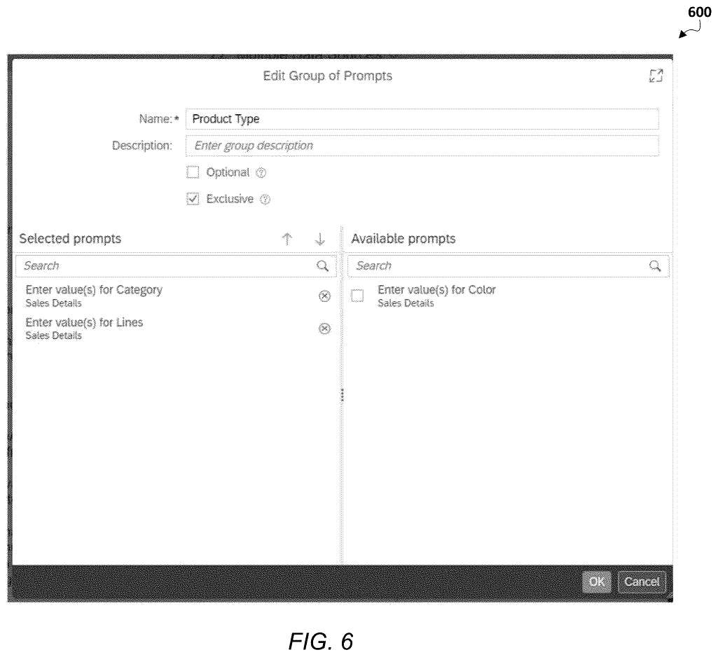

Turning now to FIG. 6, an example of a user interface 600 for creating a group of prompts is depicted, in accordance with one or more embodiments of the current subject matter. As shown in FIG. 6, user interface 600 includes a group of prompts, with the group named “Product Type”. The selected prompts for this group include category and lines as shown in the bottom left of user interface 600. Additionally, the Product Type group of prompts has been defined as an exclusive group, as shown with the check in the Exclusive box. Since this group has been specified as an exclusive group, only one prompt from this group needs to be answered by the end user. The up and down arrows to the right of the “Selected prompts” text allow the individual prompts to be moved up or down in the group to a desired position within the group. This positioning will be how the group of prompts are later presented to the user when the user is configuring their query. To the right of the selected prompts are the available prompts, which are other prompts which are available for adding to the group if the user so chooses.

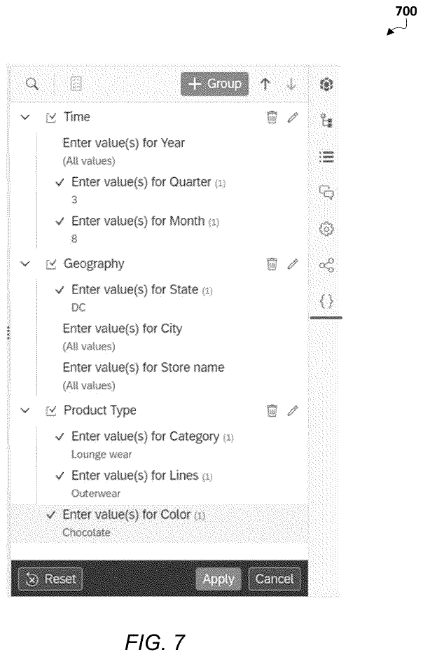

Referring now to FIG. 7, an example of a user interface 700 for displaying groups of prompts is depicted, in accordance with one or more embodiments of the current subject matter. After groups of prompts have been created, as previously described, the groups of prompts may be displayed in a user interface such as user interface 700. These include the Time, Geography, and Product Type groups. The up and down arrows may be used to move the groups up or down within user interface 700 as desired by the user. Also, the “+Group” button may be selected by the user to create a new group. If the user selects the “+Group” button, a user interface such as user interface 400 may be generated to allow the user to define the new group of prompts. At the bottom of the screen, the “Apply” button may be used to apply these groups of prompts to one or more queries.

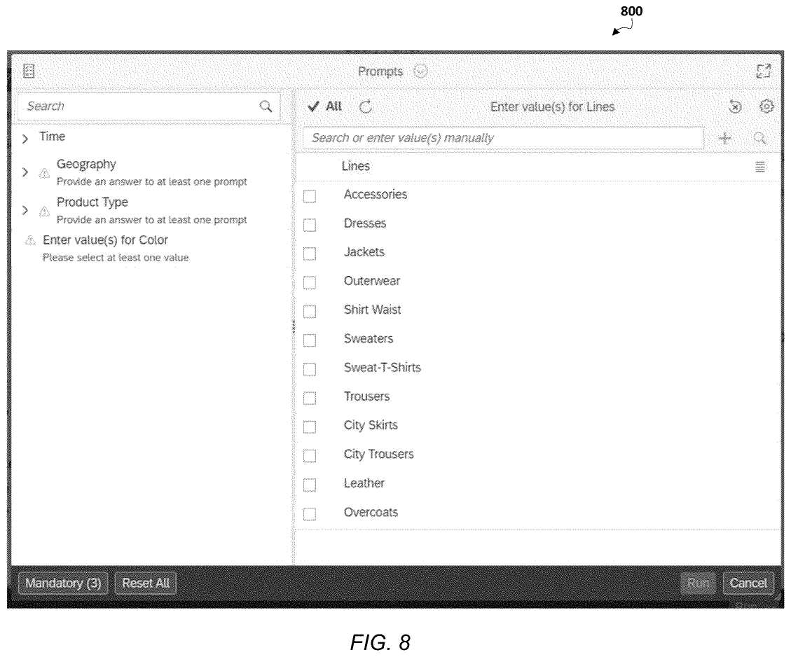

Turning now to FIG. 8, an example of a user interface 800 for displaying previously created groups of prompts prior to running a query is depicted, in accordance with one or more embodiments of the current subject matter. On the left-side of user interface 800, the previously created groups of prompts are displayed in an unexpanded form. The prompts are organized in the manner specified by the user in the previously shown user interfaces. The four prompts listed are “Time” which is a group, “Geography” which is a group, “Product Type” which is a group, and “Color” which is an individual prompt. The sideways caret symbol to the left of “Time”, “Geography”, and “Product Type” allows these groups to be expanded to show all prompts within the group. As shown in user interface 800, these group prompts are in their unexpanded state.

Additionally, the mandatory or optional nature of the prompts is indicated by the warning symbols for those prompts which have been designated as mandatory. For example, “Geography” has the warning symbol as well as the text “Provide an answer to at least one prompt”. “Product Type” also has the warning symbol and the text “Provide an answer to at least one prompt”. “Color” is also a mandatory prompt so the “Color” prompt includes the warning symbol and the text stating “Please select at least one value”. At the top of the prompts is the “Time” prompt which is optional, and so the “Time” prompt is displayed without the warning symbol and without any accompanying text. On the bottom left of user interface 800, the graphical element button displaying “Mandatory (3)” provides the indication that there are three mandatory prompts that must be answered before the query can be run.

On the right-side of user interface 800 are the list of values, which may be chosen for whichever prompt has been selected on the left-side, which in this case is the “Product Type” prompt. The user may select individual answers among this list of values on the right-side to specify for the “Product Type” category. These individual answers will then be used as filters in the subsequent query when retrieving dataset from its data source.

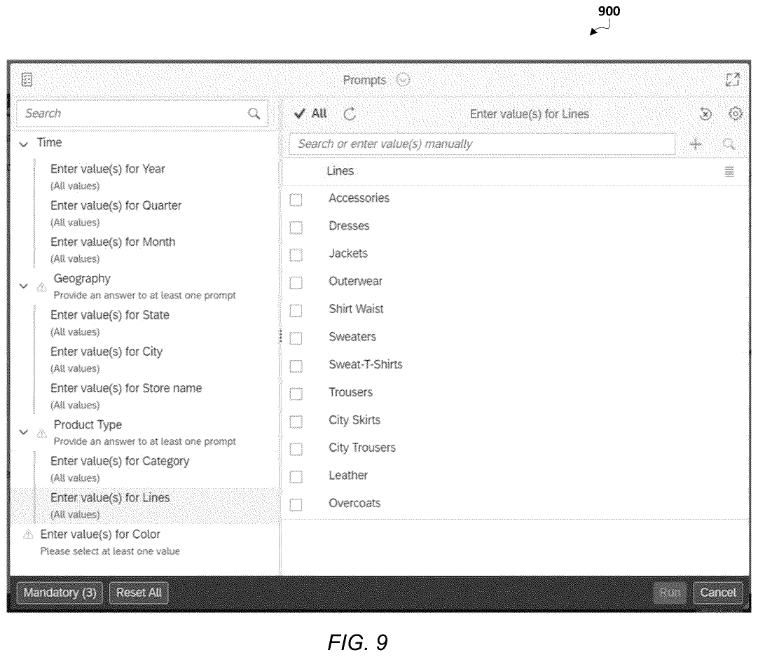

Referring now to FIG. 9, another example of a user interface 900 for answering groups of prompts is depicted, in accordance with one or more embodiments of the current subject matter. User interface 900 is associated with the same query as user interface 800 (of FIG. 8), albeit with the prompt groups expanded on the left side to show each of the individual prompts within the different groups. It is noted that the “Run” graphical element on the bottom right of user interface 900 is not enabled since the mandatory prompts have not yet been answered. In other words, the user is not able to run the query until the mandatory prompts have been answered.

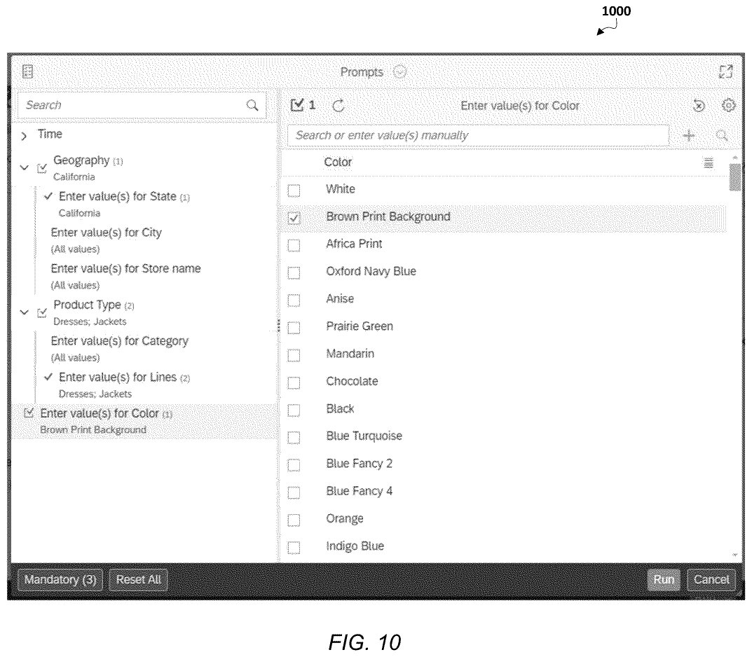

Turning now to FIG. 10, another example of a user interface 1000 for answering prompts in order to run a query is depicted, in accordance with one or more embodiments of the current subject matter. The discussion of user interface 1000 is intended to be a continuation of the discussion of user interface 900 (of FIG. 9). As such, user interface 1000 depicts user interface 900 at a later point in time after all of the mandatory prompts have been answered. Once all of the mandatory prompts have been answered, the “Run” button on the bottom right of user interface 1000 is enabled and the user is able to run the query with the values that have been selected for the prompts.

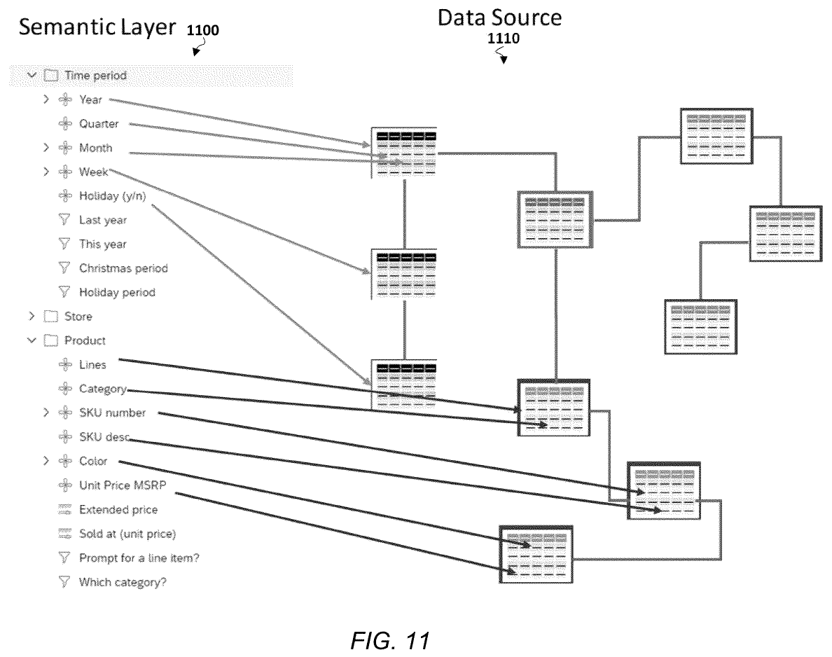

Referring now to FIG. 11, an example of a semantic layer 1100 for presenting data in a user-friendly format is depicted, in accordance with one or more embodiments of the current subject matter. As shown in FIG. 11, semantic layer 1100 is used to hide data source technical details from users and to generate queries to send to a database without prior knowledge of technical languages. As used herein, the term “semantic layer” is defined as an abstraction layer that presents data to users in a business context and in a format that is easy to understand for non-technical users. To retrieve a dataset from a data source 1110 through the semantic layer 1100, users may create a query made of objects in the semantic layer 1100 that will return the data and filters that can be used to narrow down the resulting dataset. The query is then translated by the semantic layer 1100 into the data source technical language and the generated script is sent to the database to retrieve the corresponding dataset.

A query to a data source 1110 may contain static filters that narrow down the resulting dataset at query time. For useability, these filters can also be dynamic, and their values requested from the user through prompts. Once the user has answered these prompts, the answers are injected into the query before being translated by the Semantic Layer into the data source technical language. A prompt requests the user to provide value(s) for a specific query filter. A query may have multiple filters, and hence multiple prompts. Different types of prompts may be specified by a user. These different types of prompts include, but are not limited to, mandatory and optional prompts. A mandatory prompt is a prompt that a user must answer before running a query. An optional prompt is a prompt that a user may answer before running a query. A group of prompts is a concept to gather, organize, and define behavior of multiple prompts.

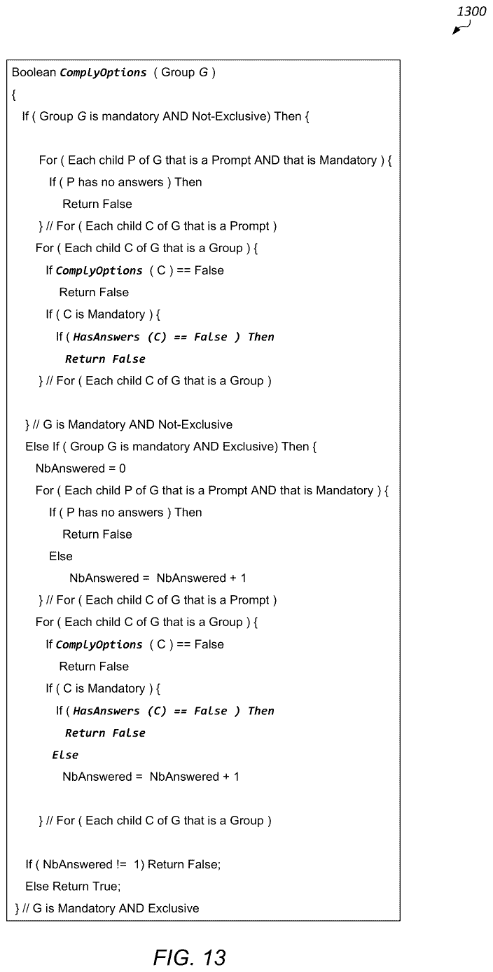

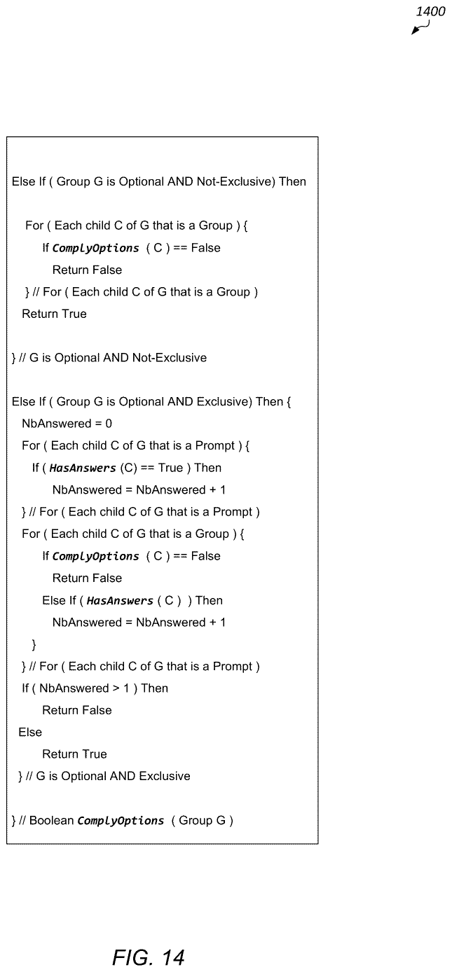

Turning now to FIG. 12, an example of pseudocode 1200 of an algorithm for checking all answered prompts prior to running a query is shown, in accordance with one or more embodiments of the current subject matter. Pseudocode 1200 presents an algorithm for determining if the mandatory prompts which are required for running a query have been answered. As shown in pseudocode 1200, if false is returned, then the corresponding query cannot be run because one or more prompts have not been answered. Otherwise, if the check all answered prompts function returns true, then the corresponding query can be run. For the second clause in the check all answered prompts function, reference is made to the ComplyOptions function, which will be presented in FIG. 13 and FIG. 14 and explained in more detail below. It is noted that pseudocode 1200 is merely one example of pseudocode that may be implemented in one particular embodiment. In other embodiments, other suitable combinations and/or arrangements of pseudocode statements may be implemented to determine if the mandatory prompts which are required for running a query have been answered.

Referring now to FIG. 13, an example of pseudocode 1300 of a portion of an algorithm for determining if all options have been complied with before executing a query is shown, in accordance with one or more embodiments of the current subject matter. Pseudocode 1300 includes a first portion of an algorithm for checking if a given group G of prompts has been answered in accordance with the rules specified for the group G in order to allow the associated query to be executed. The first portion of the algorithm presented in pseudocode 1300 includes the case when the group G is mandatory and not exclusive and the case when the group G is mandatory and exclusive. It is noted that pseudocode 1300 is merely one example of pseudocode that may be implemented in one particular embodiment. In other embodiments, other suitable combinations and/or arrangements of pseudocode statements may be implemented to determine if all options have been complied with before executing a query.

Turning now to FIG. 14, an example of pseudocode 1400 of a portion of an algorithm for determining if all options have been complied with before executing a query is shown, in accordance with one or more embodiments of the current subject matter. Pseudocode 1400 includes a second portion of an algorithm for checking if a given group G of prompts has been answered in accordance with the rules specified for the group G in order to allow the associated query to be executed. The second portion of the algorithm presented in pseudocode 1400 includes the case when the group G is optional and not exclusive and the case when the group G is optional and exclusive. It is noted that pseudocode 1400 is merely one example of pseudocode that may be implemented in one particular embodiment. In other embodiments, other suitable combinations and/or arrangements of pseudocode statements may be implemented to determine if all options have been complied with before executing a query.

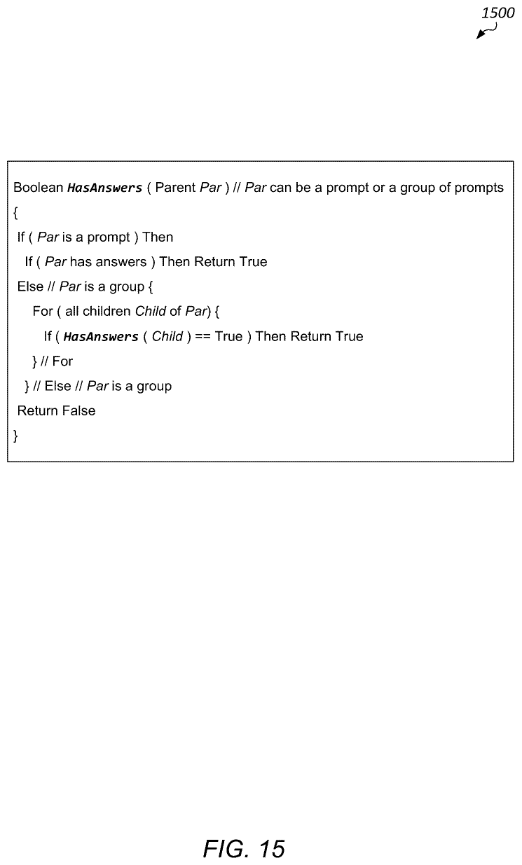

Referring now to FIG. 15, an example of pseudocode 1500 of a function for determining if a prompt or a group of prompts has been answered is shown, in accordance with one or more embodiments of the current subject matter. Pseudocode 1500 includes the HasAnswers function referenced by pseudocode 1300 (of FIG. 13) and pseudocode 1400 (of FIG. 14). If the prompt or group of prompts referenced by parameter “Par” has been answered, then the HasAnswers function returns True. Otherwise, if the prompt or group of prompts referenced by parameter “Par” have not been answered, then the HasAnswers function returns False. It is noted that pseudocode 1500 is merely one example of pseudocode that may be implemented in one particular embodiment. £ In other embodiments, other suitable combinations and/or arrangements of pseudocode statements may be implemented to determine if a prompt or a group of prompts has been answered.

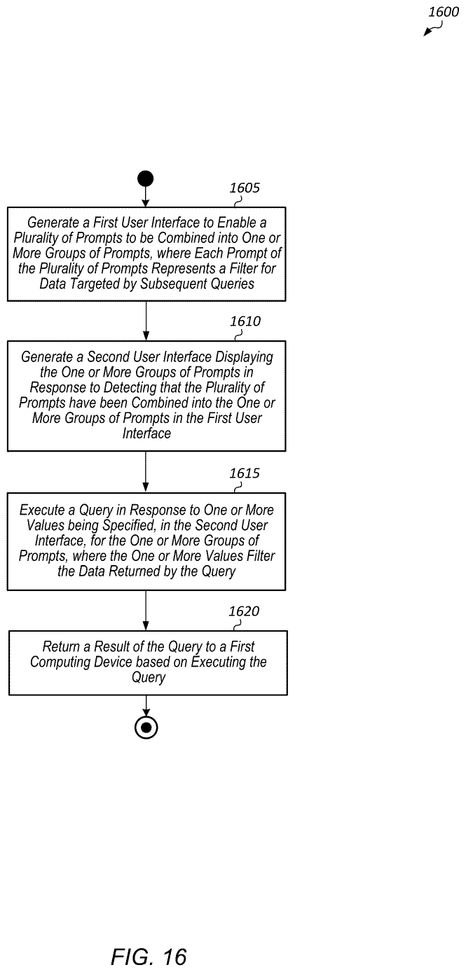

Turning now to FIG. 16, a process for grouping prompts for filtering a query is depicted, in accordance with one or more embodiments of the current subject matter. An application (e.g., application 112B of FIG. 1) generates a first user interface (e.g., user interface 400 of FIG. 4) to enable a plurality of prompts to be combined into one or more groups of prompts, where each prompt of the plurality of prompts represents a filter for data targeted by subsequent queries (block 1605). In an example, a report creator may combine the plurality of prompts into one or more groups of prompts using the first user interface. Next, the application generates a second user interface (e.g., user interface 800 of FIG. 8) displaying the one or more groups of prompts in response to detecting that the plurality of prompts have been combined into the one or more groups of prompts in the first user interface (block 1610). It is assumed for the purposes of this discussion that the second user interface is different from the first user interface.

Then, a web intelligence engine (e.g., web intelligence engine 250 of FIG. 2) executes a query in response to one or more values being specified, in the second user interface, for the one or more groups of prompts, where the one or more values filter the data returned by the query (block 1615). In other embodiments, other types of software applications besides a web intelligence engine may execute the query in block 1615. In an example, a report consumer may answer (i.e., provide values for) the one or more groups of prompts in order to run the query. The report consumer may be different from the report creater. For example, the report consumer may be a chief executive officer (CEO) of a company, an account manager, a business executive, a sales representative, or other person.

Next, the web intelligence engine returns a result of the query to a first computing device (e.g., client device 202) based on executing the query (block 1620). After block 1620, method 1600 may end.

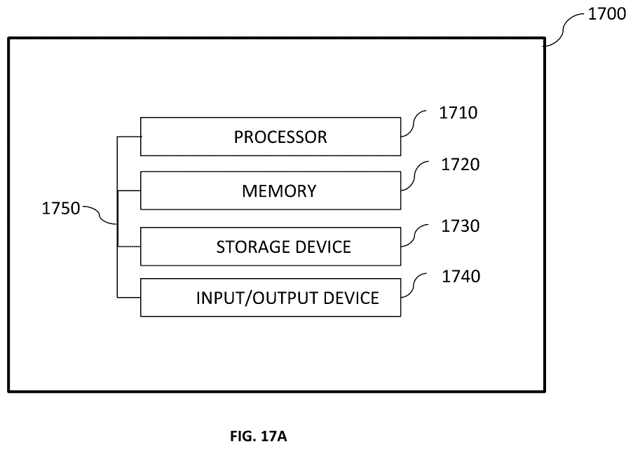

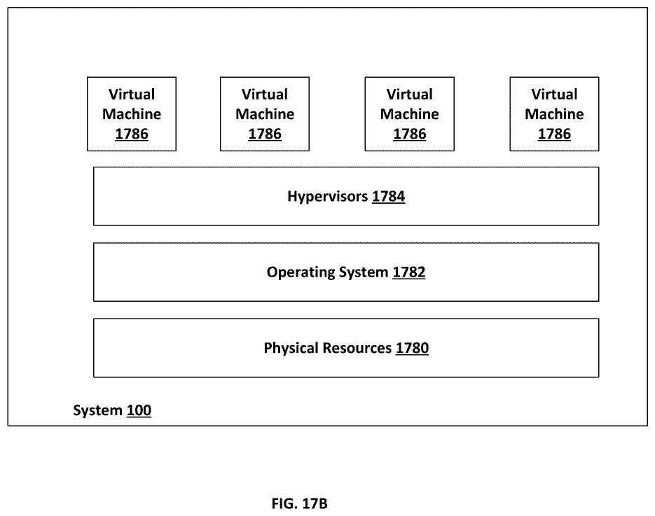

In some implementations, the current subject matter may be configured to be implemented in a system 1700, as shown in FIG. 17A. The system 1700 may include a processor 1710, a memory 1720, a storage device 1730, and an input/output device 1740. Each of the components (e.g., the processor 1710, the memory 1720, the storage device 1730, the I/O device 1740) may be interconnected using a system bus 1750. The processor 1710 may be configured to process instructions for execution within the system 1700. In some implementations, the processor 1710 may be a single-threaded processor. In alternate implementations, the processor 1710 may be a multi-threaded processor. The processor 1710 may be further configured to process instructions stored in the memory 1720 or on the storage device 1730, including receiving or sending information through the input/output device 1740. The memory 1720 may store information within the system 1700. In some implementations, the memory 1720 may be a computer-readable medium. In alternate implementations, the memory 1720 may be a volatile memory unit. In yet some implementations, the memory 1720 may be a non-volatile memory unit. The storage device 1730 may be capable of providing mass storage for the system 1700. In some implementations, the storage device 1730 may be a computer-readable medium. In alternate implementations, the storage device 1730 may be a floppy disk device, a hard disk device, an optical disk device, a tape device, non-volatile solid state memory, or any other type of storage device. The input/output device 1740 may be configured to provide input/output operations for the system 1700. In some implementations, the input/output device 1740 may include a touchscreen display capable of displaying graphical user interfaces.

FIG. 17B depicts an example implementation of the system 100 (of FIG. 1). The system 100 may be implemented using various physical resources 1780, such as at least one or more hardware servers, at least one storage, at least one memory, at least one network interface, and the like. The system 100 may also be implemented using infrastructure, as noted above, which may include at least one operating system 1782 for the physical resources 1780 and at least one hypervisor 1784 (which may create and run at least one virtual machine 1786). For example, each multitenant application may be run on a corresponding virtual machine 1786.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random-access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method, comprising: generating a first user interface to enable a plurality of prompts to be combined into one or more groups of prompts, wherein each prompt of the plurality of prompts represents a filter for data targeted by subsequent queries; generating a second user interface to display the one or more groups of prompts in response to detecting that the plurality of prompts having been combined into the one or more groups of prompts in the first user interface; executing a query responsive to one or more values being specified for the one or more groups of prompts, wherein the one or more values filter the data returned by the query; and returning a result of the query to a first computing device.

Example 2: The computer-implemented method of Example 1, further comprising enabling the one or more groups of prompts to be specified as mandatory, optional, or exclusive.

Example 3: The computer-implemented method of any of Examples 1-2, further comprising enabling a first prompt group to be specified as mandatory, wherein specifying the first prompt group as mandatory indicates that a user must answer at least one prompt from the first prompt group before the query can be executed.

Example 4: The computer-implemented method of any of Examples 1-3, further comprising enabling a second prompt group to be specified as optional, wherein specifying the second prompt group as optional indicates that the user is not required to answer any prompts from the second prompt group before the query can be executed.

Example 5: The computer-implemented method of any of Examples 1-4, further comprising enabling a third prompt group to be specified as exclusive, wherein specifying the third prompt group as exclusive indicates that the user is required to answer only one prompt from the third prompt group before the query can be executed.

Example 6: The computer-implemented method of any of Examples 1-5, wherein the second user interface is generated in response to detecting that a graphical element has been selected by a user to apply combinations of the plurality of prompts into the one or more groups of prompts, and wherein the second user interface is different from the first user interface.

Example 7: The computer-implemented method of any of Examples 1-6, further comprising displaying the one or more groups of prompts in an unexpanded form in the second user interface.

Example 8: The computer-implemented method of any of Examples 1-7, further comprising enabling a user to create a label to be applied as a name to each prompt group of the one or more groups of prompts.

Example 9: The computer-implemented method of any of Examples 1-8, further comprising enabling a plurality of groups of prompts to be displayed in the second user interface in an order specified by a user in the first user interface.

Example 10: The computer-implemented method of any of Examples 1-9, wherein the one or more groups of prompts comprise a first group and a second group, and wherein the computer-implemented method further comprising enabling, within the first user interface, the second group to be added as a sub-group of the first group.

Example 11: A system comprising: at least one processor; and at least one memory storing instructions that, when executed by the at least one processor, cause operations comprising: generating a first user interface to enable a plurality of prompts to be combined into one or more groups of prompts, wherein each prompt of the plurality of prompts represents a filter for data targeted by subsequent queries; generating a second user interface to display the one or more groups of prompts in response to detecting that the plurality of prompts having been combined into the one or more groups of prompts in the first user interface; executing a query responsive to one or more values being specified for the one or more groups of prompts, wherein the one or more values filter the data returned by the query; and returning a result of the query to a first computing device.

Example 12: The system of Example 11, wherein the operations further comprise enabling the one or more groups of prompts to be specified as mandatory, optional, or exclusive.

Example 13: The system of any of Examples 11-12, wherein the operations further comprise enabling a first prompt group to be specified as mandatory, wherein specifying the first prompt group as mandatory indicates that a user must answer at least one prompt from the first prompt group before the query can be executed.

Example 14: The system of any of Examples 11-13, wherein the operations further comprise enabling a second prompt group to be specified as optional, wherein specifying the second prompt group as optional indicates that the user is not required to answer any prompts from the second prompt group before the query can be executed.

Example 15: The system of any of Examples 11-14, wherein the operations further comprise enabling a third prompt group to be specified as exclusive, wherein specifying the third prompt group as exclusive indicates that the user is required to answer only one prompt from the third prompt group before the query can be executed.

Example 16: The system of any of Examples 11-15, wherein the second user interface is generated in response to detecting that a graphical element has been selected by a user to apply combinations of the plurality of prompts into the one or more groups of prompts, and wherein the second user interface is different from the first user interface.

Example 17: The system of any of Examples 11-16, wherein the operations further comprise displaying the one or more groups of prompts in an unexpanded form in the second user interface.

Example 18: The system of any of Examples 11-17, wherein the operations further comprise enabling a user to create a label to be applied as a name to each prompt group of the one or more groups of prompts.

Example 19: The system of any of Examples 11-18, wherein the operations further comprise enabling a plurality of groups of prompts to be displayed in the second user interface in an order specified by a user in the first user interface.

Example 20: A non-transitory computer readable storage medium storing instructions, which when executed by at least one data processor, result in operations comprising: generating a first user interface to enable a plurality of prompts to be combined into one or more groups of prompts, wherein each prompt of the plurality of prompts represents a filter for data targeted by subsequent queries; generating a second user interface to display the one or more groups of prompts in response to detecting that the plurality of prompts having been combined into the one or more groups of prompts in the first user interface; executing a query responsive to one or more values being specified for the one or more groups of prompts, wherein the one or more values filter the data returned by the query; and returning a result of the query to a first computing device.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method comprising:
generating a first user interface displaying a plurality of prompts, wherein each prompt of the plurality of prompts represents a filter for data targeted by subsequent queries;
receiving, via the first user interface, a first user selection of a graphical element to combine the plurality of prompts into one or more groups of prompts;
generating a second user interface that is different from the first user interface in response to the first user selection received via the first user interface, the second user interface displaying the one or more groups of prompts, each group of prompts being expandable to show all prompts within the group, alongside filter values corresponding to a selected group of prompts;
receiving, via the second user interface, a second user selection of one or more of the filter values corresponding to the selected group of prompts;
executing a query responsive to the second user selection received via the second user interface, wherein the one or more filter values filter data returned by the query; and
returning the filtered data to a first computing device.

2. The computer-implemented method of claim 1, further comprising enabling the one or more groups of prompts to be specified as mandatory, optional, or exclusive.

3. The computer-implemented method of claim 2, further comprising enabling a first prompt group to be specified as mandatory, wherein specifying the first prompt group as mandatory indicates that a user must answer at least one prompt from the first prompt group before the query can be executed.

4. The computer-implemented method of claim 3, further comprising enabling a second prompt group to be specified as optional, wherein specifying the second prompt group as optional indicates that the user is not required to answer any prompts from the second prompt group before the query can be executed.

5. The computer-implemented method of claim 4, further comprising enabling a third prompt group to be specified as exclusive, wherein specifying the third prompt group as exclusive indicates that the user is required to answer only one prompt from the third prompt group before the query can be executed.

6. (canceled)

7. The computer-implemented method of claim 1, further comprising displaying the one or more groups of prompts in an unexpanded form in the second user interface.

8. The computer-implemented method of claim 1, further comprising enabling a user to create a label to be applied as a name to each prompt group of the one or more groups of prompts.

9. The computer-implemented method of claim 1, further comprising enabling a plurality of groups of prompts to be displayed in the second user interface in an order specified by a user in the first user interface.

10. The computer-implemented method of claim 1, wherein the one or more groups of prompts comprise a first group and a second group, and wherein the computer-implemented method further comprising enabling, within the first user interface, the second group to be added as a sub-group of the first group.

11. A system comprising:
at least one processor; and
at least one memory storing instructions that, when executed by the at least one processor, cause operations comprising:
generating a first user interface displaying a plurality of prompts, wherein each prompt of the plurality of prompts represents a filter for data targeted by subsequent queries;
receiving, via the first user interface, a first user selection of a graphical element to combine the plurality of prompts into one or more groups of prompts;
generating a second user interface that is different from the first user interface in response to the first user selection received via the first user interface, the second user interface displaying the one or more groups of prompts, each group of prompts being expandable to show all prompts within the group, alongside filter values corresponding to a selected group of prompts;
receiving, via the second user interface, a second user selection of one or more of the filter values corresponding to the selected group of prompts;
executing a query responsive to the second user selection received via the second user interface, wherein the one or more filter values filter data returned by the query; and
returning the filtered data to a first computing device.

12. The system of claim 11, wherein the operations further comprise enabling the one or more groups of prompts to be specified as mandatory, optional, or exclusive.

13. The system of claim 12, wherein the operations further comprise enabling a first prompt group to be specified as mandatory, wherein specifying the first prompt group as mandatory indicates that a user must answer at least one prompt from the first prompt group before the query can be executed.

14. The system of claim 13, wherein the operations further comprise enabling a second prompt group to be specified as optional, wherein specifying the second prompt group as optional indicates that the user is not required to answer any prompts from the second prompt group before the query can be executed.

15. The system of claim 14, wherein the operations further comprise enabling a third prompt group to be specified as exclusive, wherein specifying the third prompt group as exclusive indicates that the user is required to answer only one prompt from the third prompt group before the query can be executed.

16. (canceled)

17. The system of claim 11, wherein the operations further comprise displaying the one or more groups of prompts in an unexpanded form in the second user interface.

18. The system of claim 11, wherein the operations further comprise enabling a user to create a label to be applied as a name to each prompt group of the one or more groups of prompts.

19. The system of claim 11, wherein the operations further comprise enabling a plurality of groups of prompts to be displayed in the second user interface in an order specified by a user in the first user interface.

20. A non-transitory computer readable storage medium storing instructions, which when executed by at least one data processor, result in operations comprising:
generating a first user interface displaying a plurality of prompts, wherein each prompt of the plurality of prompts represents a filter for data targeted by subsequent queries;
receiving, via the first user interface, a first user selection of a graphical element to combine the plurality of prompts into one or more groups of prompts;
generating a second user interface that is different from the first user interface in response to the first user selection received via the first user interface, the second user interface displaying the one or more groups of prompts, each group of prompts being expandable to show all prompts within the group, alongside filter values corresponding to a selected group of prompts;
receiving, via the second user interface, a second user selection of one or more of the filter values corresponding to the selected group of prompts.
executing a query responsive to the second user selection received via the second user interface, wherein the one or more filter values filter data returned by the query; and
returning the filtered data to a first computing device.
